(19) United States
(12) Patent Application Publication
(10) Pub. No.: US 2002/0062292 A1
(43) Pub. Date: May 23, 2002

(54) Goods purchase information processing method and system

(76) Inventors: Isao Iwaguchi, Kawasaki (JP); Mitsuharu Ishii, Kawasaki (JP); Kozo Yamazaki, Kawasaki (JP)

Correspondence Address: STAAS & HALSEY LLP, 700 11TH STREET, NW, SUITE 500, WASHINGTON, DC, 20001, US

(21) Appl. No.: 09/800,489

(22) Filed: Mar. 8, 2001

(30) Foreign Application Priority Data
Nov. 17, 2000 (JP) 2000-350902

(51) Int. Cl. G06F 17/60; H04K 1/00; H04L 9/00

(52) U.S. Cl. 705/64; 705/41

(57) ABSTRACT

The present invention relates to goods purchase information processing method and system whereby a goods purchaser can enter goods purchase information into a processing device they own. It allows automatic input of product purchase information into the processing device. Mobile terminals, such as information terminals or mobile telephones (1), which are available to the ordinary consumer, are used. A store sends product purchase information from a settlement device (2, 3) to the mobile terminal (1). The information is stored in the mobile terminal (1). The user therefore holds electronic data relating to the product purchase information (receipt) in their mobile terminal (1) and when they return home or to the office, the user can automatically enter this information into a processing device (4) such as an accounting system.

### BACKGROUND OF THE INVENTION

1. Field of the Invention

The present invention relates to a goods purchase information processing method and system for data entry of purchase information, for products purchased from a store selling products, in a processing device situated in a place other than the store and more particularly to a goods purchase information processing method and system for automatic entry of goods purchase information.

2. Description of the Related Art

With the improved performance and lower prices of personal electronic equipment in recent years, individuals can now use such equipment for a wide variety of purposes. One example of the use of such equipment is in the individual use of accounting systems, typified by the so-called household budget. To use this accounting system, the user must record goods purchases, for example by entering purchase data in the accounting system.

FIG. 8 is a schematic view of a conventional system. The customer 8 goes to the store 300, which sells the product (good or service), and purchases the product. The product code is entered into the POS (point of sale) terminal 100, for example the bar code 200 of the purchased product is read. The POS terminal 100 calculates the total price and processes the settlement. The customer 8 pays the settlement price. The POS terminal 100 then issues a receipt 210 on which the purchase details are recorded.

The customer 8 takes the receipt 210. The customer 8 returns home, looks at the receipt 210, and uses the keyboard to enter the purchase details recorded on the receipt 210 into household budget software on their personal computer (PC). The customer 8 uses the household budget software 110 and processes the information by subject and date. In conventional accounting systems, the history of purchases made at store 300 is entered manually in this way.

The manual input of information into these accounting systems requires the entry of data for each product purchased and therefore brings with it the problems of complexity and time. For example, when a keyboard is used, the date and time of the purchase, the store at which the purchase was made, the name of the purchased product, and the price of the purchase must be entered manually for each product. OCR (Optical Character Reader) may also be used. But, because the letters used on the receipts of different stores are not necessarily the same, incorrect recognition cannot be avoided. Everything must be checked on screen and corrected manually.

### SUMMARY OF THE INVENTION

Accordingly, an object of the present invention is to provide a goods purchase information processing method and system for automatic entry of product purchase information into an accounting system.

A further object of the present invention is to provide a goods purchase information processing method and system for providing a customer service in stores that enables automatic entry of product purchase information into an accounting system.

A still further object of the present invention is to provide a goods purchase information processing method and system that will enable the simple introduction into stores of a customer service that enables automatic entry of goods purchase information into an accounting system.

To achieve these objects, the goods purchase information processing method of the present invention comprises: a step for calculating goods settlement information from goods information for goods purchased by an user and processing the settlement with a store device, and a step for sending the goods purchase information, which includes the above product settlement information, from the store device to a mobile terminal of the above user for communicating with a processing device for the above user to store the information in the mobile terminal.

Also, the goods purchase information processing system of the present invention comprises; settlement means for calculating goods settlement information in a store from goods information of the goods purchased by the user; and communication means for sending goods purchase information, which includes the above product settlement information, to a mobile terminal of the above user for communicating with a processing device for the above user.

The present invention uses mobile terminals such as mobile information terminals or mobile telephones which are now available to the ordinary consumer. In the store, the goods purchase information is sent to the mobile terminal from the settlement device and stored in the mobile terminal, enabling the user to hold electronic product purchase information (receipt) data on the mobile terminal. Because the user holds electronic data in the mobile terminal that they carry around, the user can take the mobile terminal back to their home or office and automatically enter the data into a processing device such as an accounting system.

Also, by merely carrying the mobile terminal, the user can automatically enter receipt information without having to do any work. Furthermore, the store is able to provide users with this special service and thus contribute to its sales promotions.

In addition, in the present invention, it is preferable that the above settlement step comprises a step of reading the goods information for the goods purchased by the above user withe a reader of the above settlement device, and a step of calculating the goods settlement information in a register terminal of the above settlement device from the product information read as above and processing the settlement. These steps will enable automatic settlement at the store, transmission of the product purchase information from the settlement device to the mobile terminal, and storage of the information in the mobile terminal.

Furthermore, in the present invention, it is preferable that the above transmission step comprises a step for sending the above goods purchase information from the above reader to the mobile terminal. This will mean that instead of having to change the whole settlement system, a store will merely have to install or replace the reader in order to be able to provide the associated services and contribute to a reduction in the installation cost.

### BRIEF DESCRIPTION OF THE DRAWINGS

FIG. 1 is a schematic view of a system in an aspect of the embodiment of the present invention;

FIG. 2 is a block diagram of a first aspect of the embodiment of the present invention;

FIG. 3 shows the flow of processing in the aspect of the embodiment shown in FIG. 2;

FIG. 4 explains the receipt information shown in FIG. 3;

FIG. 5 is a block diagram of a second aspect of the embodiment of the present invention;

FIG. 6 shows the flow of processing in the aspect of the embodiment shown in FIG. 5;

FIG. 7 explains a third aspect of the embodiment of the present invention; and

FIG. 8 is a schematic view of a conventional product purchase information processing system.

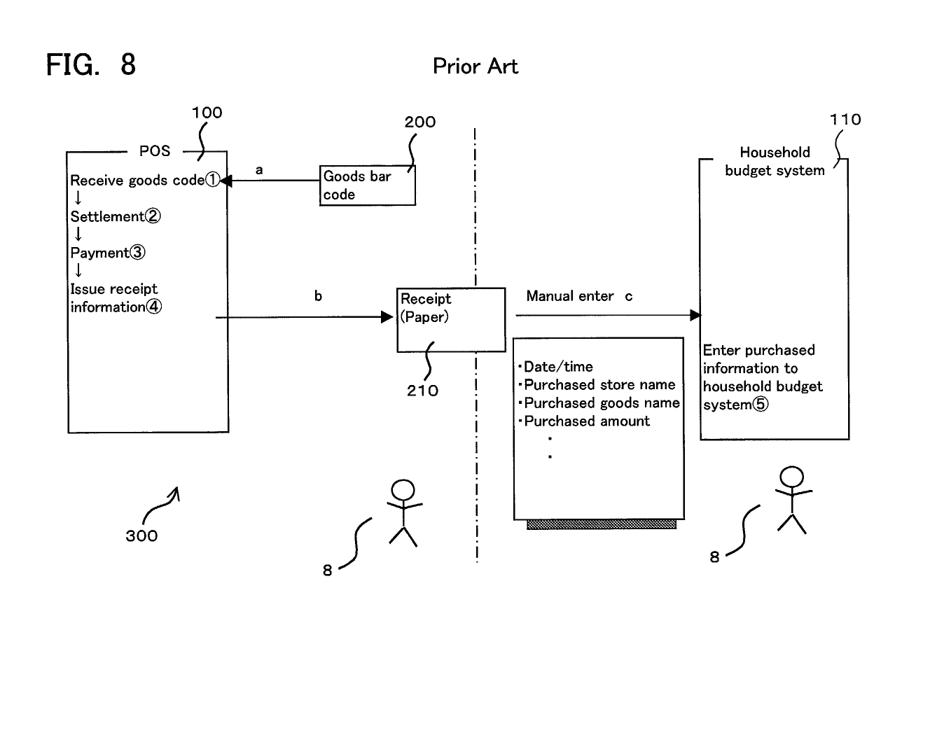

### DESCRIPTION OF THE PREFERRED EMBODIMENTS

Based on drawings, the aspects of the embodiments of the present invention will be explained in the following order: goods purchase information processing system, a first aspect of the embodiment, a second aspect of the embodiment, a third aspect of the embodiment, and other aspects of the embodiment.

Goods Purchase Information Processing System

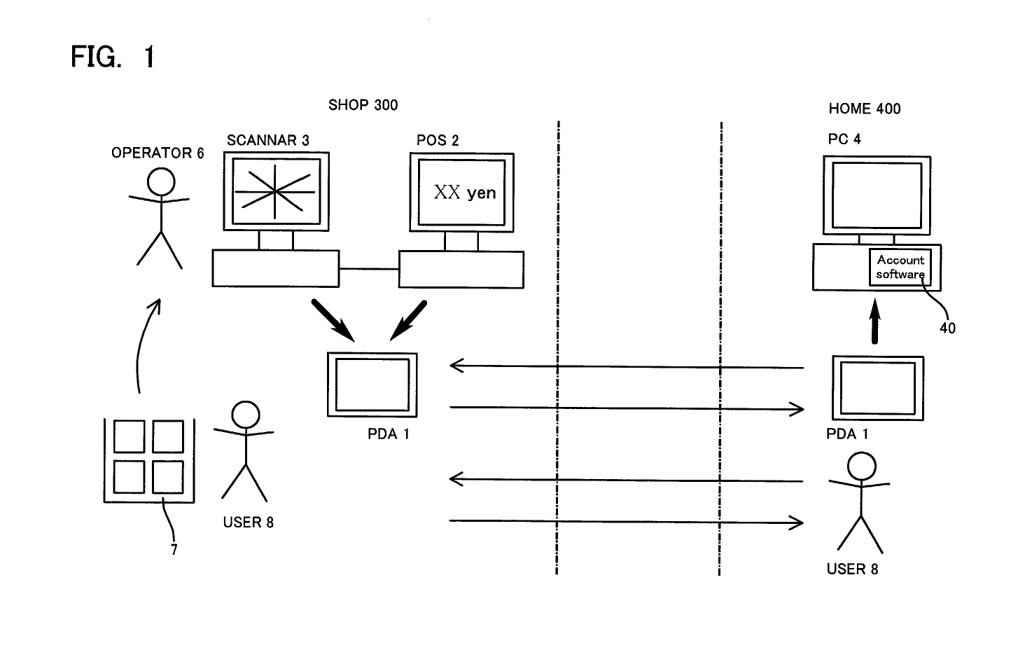

FIG. 1 is a schematic view of a goods purchase information system in an aspect of the embodiment of the present invention. As shown in FIG. 1, the store (for example, supermarket or convenience store) 300 that sells the product (good or service) is equipped with a scanner 3 for reading the bar codes of the products 7, and a POS register (sale terminal) 2 that is connected to the scanner 3 and that processes the settlement.

On the other hand, a personal computer 4 onto which accounting software 40 is loaded is provided in a home or office 400. The user 8 has a mobile terminal 1. A suitable mobile terminal 1 is one of a size and weight that is easily carried by the user 8, for example, a personal digital assistant (PDA), or is a mobile telephone.

The method by which this system is used will be explained. Firstly, the user 8 carries the mobile terminal 1 and goes to the store 300 to purchase products. At the store 300, the user 8 fetches the desired products 7 and takes them to the store 300 register for settlement. At the register, the operator 6 uses the scanner 3 to read the bar codes of the products 7 and enter the product bar codes in the POS register 2. When needed, a product code is entered using the numeric keypad on the scanner 3.

The POS register 2 searches for the product names and prices from the product codes and calculates the total price. When the user pays the total price using cash or a card etc., the settlement ends at the POS register and a receipt is issued. A feature of the present invention is that the product purchase information on the receipt is transmitted to the mobile terminal 1 of the user 8 from the POS register 2 or the scanner 3. The mobile terminal 1 receives and stores this information in internal memory.

The user 8 takes the mobile terminal 1 and products 7 and returns to their home or office 400. They then make a wired or unwired connection from the mobile terminal 1 to the personal computer 4 and transfer the product purchase information, which is stored in the memory of the mobile terminal 1, to the personal computer 4. The information is then entered into the accounting software.

Thus, the present invention uses mobile information terminals or mobile telephones 1, which are available to the ordinary consumer. At the store 300, receipt information from the POS register 2 is sent to the mobile terminal 1 and stored there. This means that the user 8 can hold electronic receipt data in the mobile terminal 1. Because the user holds electronic data in the mobile terminal 1 that they carry around, the user 8 can automatically enter the data into an accounting system 40 such as a household budget system when they take the mobile terminal 1 back to their home or office.

Also, merely by carrying the mobile terminal 8, the user 8 can automatically enter receipt information without having to do any work. Furthermore, the store 300 is able to provide users 8 with this special service and thus contribute to its sales promotions.

A First Aspect of the Embodiment

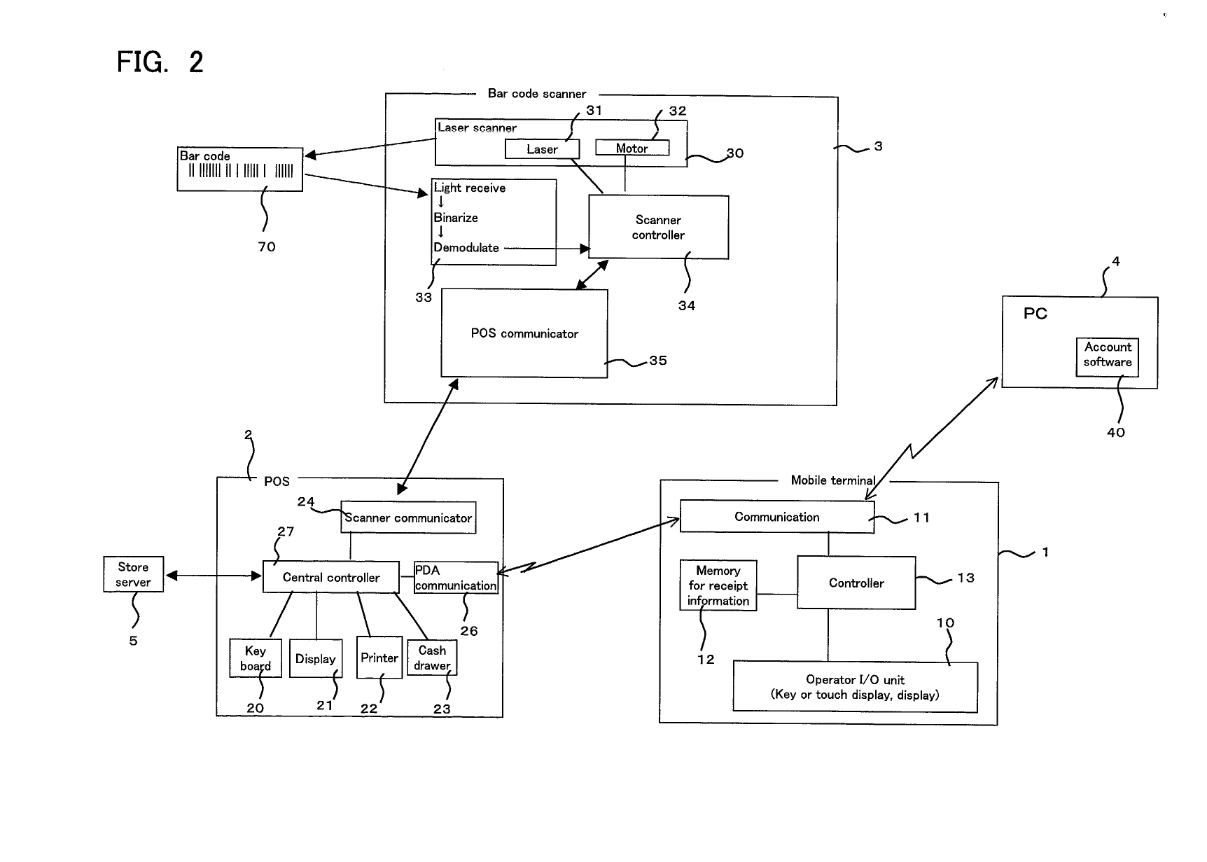

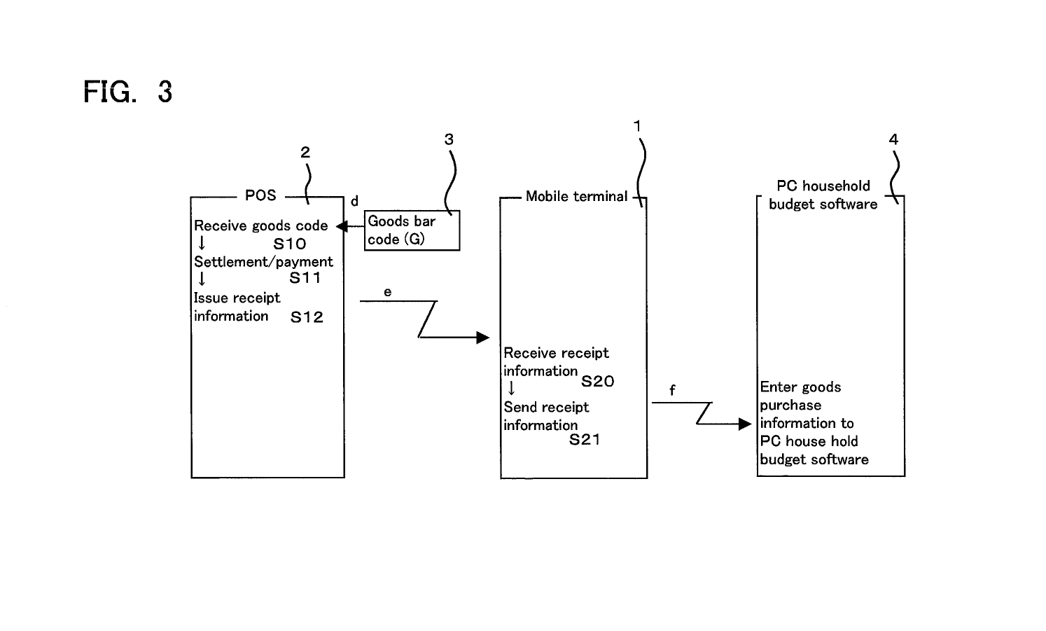

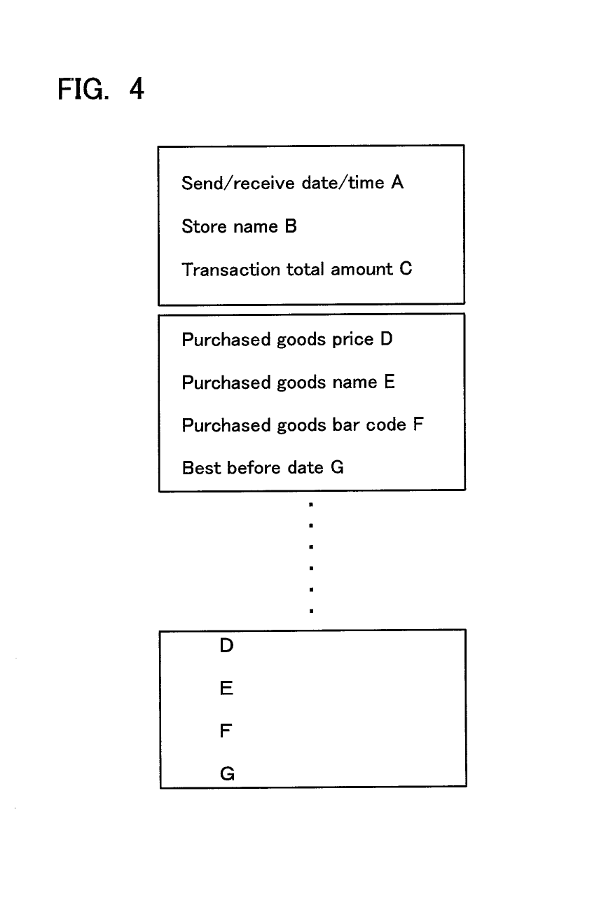

FIG. 2 is a block diagram of a system in a first aspect of the embodiment of the present invention. FIG. 3 shows the flow of processing in that system, and FIG. 4 explains the receipt information.

As shown in FIG. 2, the POS terminal 2 has a scanner communication unit 24 that receives product codes from the product code input terminal 3, a central controller 27 that processes the settlement for an amount that corresponds to the product codes, and a PDA (Personal Digital Assistant) transmitter 26 that sends the results of product settlement to the mobile information terminal 1. Furthermore, a keyboard 20, display 21, printer 22, and cash drawer 23 are connected to the central controller 27. This POS terminal 2 is connected to the store server 5.

The product code input terminal 3 that is connected to the POS terminal 2 comprises a bar code scanner. The bar code scanner 3 has a laser scanner 30 that scans product bar codes 70; a signal processor 33 that receives the light reflected from the bar code 70, demodulates it as a binary value; a scanner controller 34; and a communication unit 35 that sends bar codes to the POS terminal 2. The laser scanner 30 has a laser light source 31 and a motor 32 that drives the light scanner.

The mobile information terminal 1 receives the product settlement results from the POS terminal 2. The terminal has a communication unit 11 that sends the received product settlement results to the household budget system (accounting software 40 in the personal computer 4), a controller 13, memory 12 that stores the received product settlement information, and an operator input-output unit 10 (for example, a keyboard and a display or a touch screen).

The personal computer 4 receives the product settlement information from the mobile information terminal 1 and has a function to enable input into the accounting software 40.

In the above system configuration, product settlement information from the POS terminal 2, which is the automatic product settlement device, is sent to the mobile terminal 1 from which it can be easily entered into the household budget system. The purchase information (receipt information) is automatically entered into the household budget system with no manual work required. Therefore, the complexities of product settlement information entry are eliminated.

Next, FIG. 3 will be used to explain the processing of product purchase information, with reference to FIG. 4.

(S10) The POS terminal 2 firstly receives the product bar code information from a bar code input device 3 such as a bar code scanner.

(S11) The POS terminal 2 computes the product name and product price from the bar code information and calculates the total price of all products. The operator arranges for payment of this amount by the purchaser in cash.

(S12) Here, the POS terminal 2 issues a receipt and sends the receipt information to the mobile terminal 1. The receipt information sent includes, as shown in FIG. 4, the information transmission date and time A, the store name B, the total amount C, the purchase prices D, the purchased product names E, the product bar codes F, and the best before date G, and so forth.

(S20) The product purchaser receives and stores the receipt product information issued by the POS terminal 2 on the mobile information terminal 1 they own. The functions built into this mobile information terminal 1 are not simply those of a simple telephone or personal information terminal but include payment settlement functions and functions that enable data communication with other devices. Receipt information is exchanged using the means of communication provided by the mobile information terminal 1, in particular wireless means (SS wireless, Bluetooth, PHS communication, etc.). The receipt information received is temporarily stored in the memory 12 of the mobile information terminal 1.

(S21) The product purchaser then returns home or to the office and the mobile terminal 1 transfers the previously received receipt information to the household budget software 40 on the personal computer 4, and completes input. Also here, either wireless communication or of course wired communication can be used. Ordinarily, wired communication is used.

The “Settlement” key on the keyboard 20, which is provided for the POS terminal 2, can be set as the trigger for sending this receipt information from the POS terminal 2 to the mobile information terminal 1.

Also, after cash to the equivalent of the total price has been exchanged between the shop assistant and purchaser in accordance with the settlement, the “Issue receipt” key on the keyboard 20 can be used to trigger transfer of receipt information to the mobile information terminal 1 owned by the purchaser.

It is also possible to set the “Receive” key on the input-output unit 10 of the mobile information terminal 1 as the trigger for receiving receipt information. This enables the product purchaser to receive the information when they so desire and can be more convenient for the product purchaser.

A Second Aspect of the Embodiment

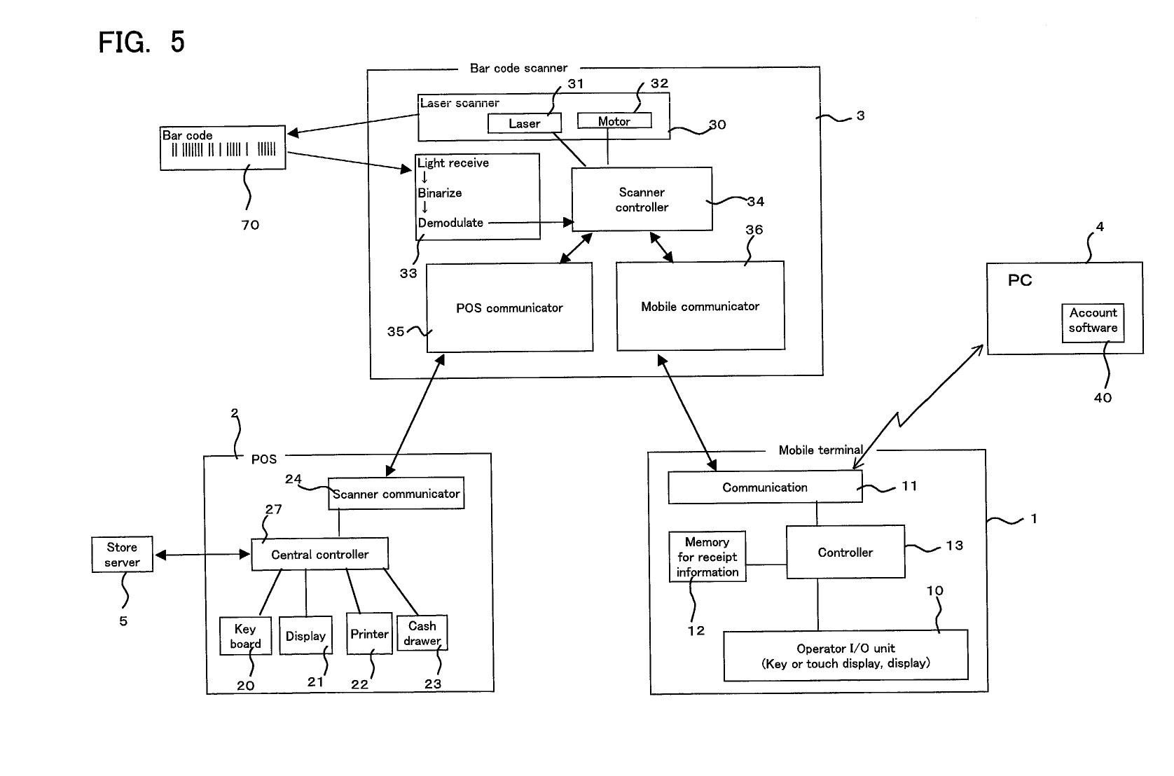

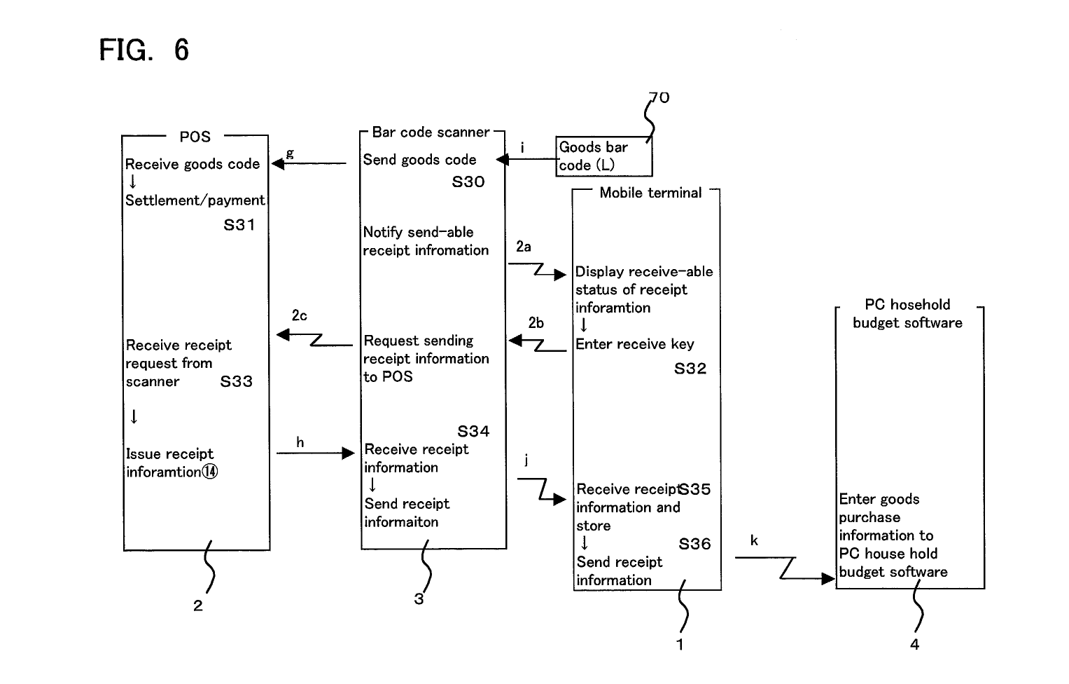

FIG. 5 is a block diagram of a second aspect of the embodiment of the present invention. FIG. 6 shows the flow of processing of the system in FIG. 5. In FIG. 5, those items that are the same as those in FIG. 2 are represented by the same codes. In this example, the bar code scanner 3 is provided with a mobile communication unit 36 for communicating with mobile terminals 1.

That is, while the bar code scanner 3 essentially reads the product bar codes and is a device for sending these to the POS terminal 2, it is also used as the store terminal for entering product bar codes and for exchanging receipts with mobile information terminals 1.

In the first aspect of the embodiment described above, the POS terminal 2 has the functions required to exchange this receipt information with a mobile information terminal 1, and so when a replacement is required the entire POS unit must be replaced. This is likely to be expensive. In this aspect of the embodiment, the receipt transmission function is built into the bar code scanner 3 and so replacement costs are relatively low.

Processing operations will be explained using FIG. 6.

(S30) Firstly, the bar code scanner 3 reads the product codes and sends the results of the readings to the POS terminal 2. The bar code scanner 3 informs the mobile terminal 1 that receipt information can be sent.

(S31) The POS terminal 2 computes the product names and prices from the product codes received, and calculates the total price.

(S32) The mobile terminal 1 receives the information that transmission is possible and shows that reception is enabled on its display 10. The user then presses the key required to receive information on the mobile terminal 1.

(S33) This information is received by the scanner 3 which then requests transmission of receipt information by the POS terminal 2. The POS terminal 2 receives the request for the receipt and issues receipt information. This causes the receipt to be issued and the receipt information is then sent to the bar code scanner 3.

(S34) The bar code scanner 3 sends the receipt information received from the POS terminal 2 to the mobile information terminal 1 owned by the purchaser.

(S35) The mobile information terminal 1 receives the receipt information from the bar code scanner 3 and temporarily stores the data in the memory 12.

(S36) The product purchaser then returns home or to the office and the mobile terminal 1 transfers the previously received receipt information to the household budget software 40 on the personal computer 4, and completes input. Also here, either wireless communication, or of course wired communication can be used. Ordinarily, wired communication is used.

The “Settlement” key on the keyboard 20 provided for the POS terminal 2 is also a suitable key to set as the trigger for sending this receipt information from the POS terminal 2 to the mobile information terminal 1.

Also, after cash to the equivalent of the total price has been exchanged between the shop assistant and purchaser in accordance with the settlement, the “Issue receipt” key on the keyboard 20 can be used to trigger transmission of receipt information to the mobile information terminal 1 owned by the purchaser.

A Third Aspect of the Embodiment

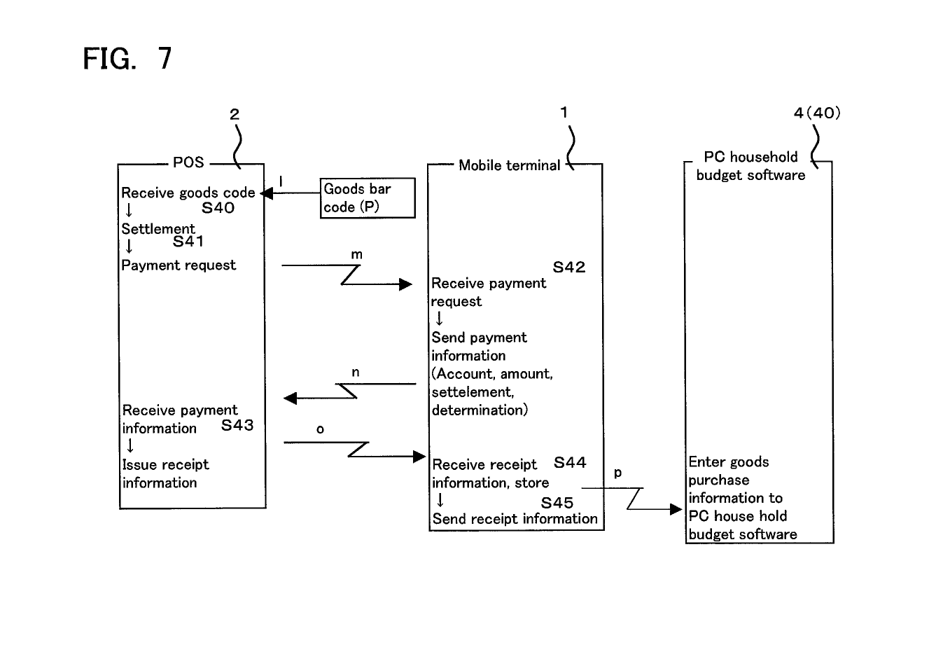

FIG. 7 shows the flow of processing in a third aspect of the embodiment of the present invention. In the example shown in FIG. 7, the mobile information terminal 1 has a function to enable online payment of charges.

(S40) The POS terminal 2 firstly receives the product bar code information from a product bar code input device 3, such as a bar code scanner.

(S41) The POS terminal 2 computes the product names and product prices from this bar code information and calculates the total price for the products. The operator presses the “Payment request” key and sends a request for payment to the mobile terminal 1.

(S42) The mobile information terminal 1 receives and displays the payment request. The user confirms the request and sends cash payment information, including settlement determination information, the withdrawal account, and the withdrawal amount and so forth, from the mobile terminal 1 to the POS register 2.

(S43) After the POS register 2 has received the withdrawal information, it seeks confirmation that the information is being sent from the person in question. After this confirmation has been received, the transaction is completed (settled). When the settlement ends, the receipt information is sent to the mobile information terminal 1 of the purchaser.

(S44) The product purchaser receives and stores the product receipt information issued by the POS register 2 on the mobile information terminal 1 they own. The functions built into this mobile information terminal 1 are not simply those of a simple telephone or personal information terminal but include payment settlement functions and functions that enable data communication with other devices. Receipt information is exchanged using communication means provided by the mobile information terminal 1, in particular wireless means (SS wireless, Bluetooth, PHS communication, etc.). The receipt information received is temporarily stored in the memory 12 of the mobile information terminal 1.

(S45) The product purchaser then returns home or to the office and the mobile terminal 1 transfers the previously received receipt information to the household budget software 40 on the personal computer 4, and completes input. Here too, either wireless communication, or of course wired communication can be used. Ordinarily, wired communication is used.

Thus, purchase information (receipt information) output from the POS register can be automatically entered into a household budget input system without any manual input being required. Therefore, the complexities of input are eliminated. Incorrect input caused by typing errors is also avoided.

Other Aspects of the Embodiment

In the above aspects of the embodiment, the accounting systems have been explained as personal household budgets. However, the present invention can also be applied to business accounting systems. Also, the store involved can be a store that sells products such as a supermarket, variety store, convenience store, or speciality store, or an establishment that provides a service, such as a restaurant.

Aspects of the embodiment of the present invention have been explained above, but various modifications of the present invention within the scope of the invention are possible. These modifications are not excluded from the technical scope of the present invention.

(1) The present invention uses mobile information terminals or mobile telephones, which are available to the ordinary consumer. At the store, product purchase information from the settlement device is sent to the mobile terminal and stored there. This means that the user can hold electronic data relating to the product purchase information (receipt) in the mobile terminal. Because the user holds electronic data in the mobile terminal that they carry around, the user can automatically enter the data into a processing device, such as an accounting system, when they take the mobile terminal back to their home or office.

(2) Also, by merely carrying the mobile terminal, the user can automatically enter receipt information without having to do any work.

(3) Furthermore, the store is able to provide users with this special service and thus contribute to its sales promotions.

What is claimed is:

1. A goods-purchase information processing method, using a store settlement device, comprising the steps of:
calculating goods settlement information from goods information for goods purchased by an user and for processing the settlement; and
sending goods purchase information, including said product settlement information, to a mobile terminal of said user, and storing the information in said mobile terminal to communicate with a processing device for said user.

2. The goods purchase information processing method according to claim 1, wherein said calculating step comprises the steps of:
reading the goods information for the goods purchased by said user using a reader on said settlement device; and
calculating the goods settlement information from said read goods information on a register terminal of said settlement device and processing the settlement.

3. The goods purchase information processing method according to claim 2, wherein said transmission step comprises a step for sending said goods purchase information to said mobile terminal from said reader.

4. The goods purchase information processing method according to claim 2, wherein said transmission step comprises a step for sending said goods purchase information to said mobile terminal from said register terminal.

5. The goods purchase information processing method according to claim 1, wherein said transmission step comprises a step for transferring said goods settlement information to said mobile terminal in response to a prompt from means for prompting calculation of said goods settlement information in said settlement device.

6. The goods purchase information processing method according to claim 1, wherein said transmission step comprises a step for transferring said goods settlement information to said mobile terminal in response to a prompt from means for prompting transmission of said goods settlement information in said settlement device.

7. The goods purchase information processing method according to claim 1, wherein said transmission step comprises a step for transferring said goods settlement information to said mobile terminal in response to a prompt from means for prompting reception by said mobile terminal.

8. The goods purchase information processing method according to claim 1, wherein said settlement step comprises a step for receiving payment information from said mobile terminal and processing said settlement.

9. A goods purchase information processing system in a store, comprising:
settlement means for calculating the goods settlement information from goods information for goods purchased by an user and for processing the settlement; and
communication means for sending goods purchase information, including said goods settlement information, to a mobile terminal of said user to communicate with a processing device for said user.

10. The goods purchase information processing system according to claim 9, wherein said settlement means comprises;
a reader for reading goods information for goods purchased by said user; and
a register terminal for calculating the goods settlement information from said read goods information and processing the settlement.

11. The goods purchase information processing system according to claim 10, wherein said reader sends said goods purchase information to said mobile terminal.

12. The goods purchase information processing system according to claim 10, wherein said register terminal sends said goods purchase information to said mobile terminal.

13. The goods purchase information processing system according to claim 9, wherein said settlement device transfers said goods settlement information to said mobile terminal in response to a prompt from means of prompting calculation of said goods settlement information.

14. The goods purchase information processing system according to claim 9, wherein said settlement device transfers said goods settlement information to said mobile terminal in response to a prompt from means of prompting transfer of said goods settlement information.

15. The goods purchase information processing system according to claim 9, wherein said settlement device transfers said goods settlement information to said mobile terminal in response to a prompt from means of prompting reception by said mobile terminal.

16. The goods purchase information processing system according to claim 9, wherein said settlement device receives payment information from said mobile terminal and processes said settlement.

17. A bar code scanner, comprising:
means for reading bar codes found on goods;
means for transferring said read bar codes to an automatic product settlement device;
means for receiving goods purchase information from said automatic product settlement device; and
means for sending said received goods purchase information to a mobile information terminal.
